(19) United States
(12) Patent Application Publication
(10) Pub. No.: US 2019/0176106 A1
(43) Pub. Date: Jun. 13, 2019

(54) DEVICE FOR TREATING MATERIAL, COMPRISING A CONTAINER

(71) Applicant: Hans-Joachim BOLTERSDORF, Brohl-Luetzing (DE)

(72) Inventor: Hans-Joachim BOLTERSDORF, Brohl-Luetzing (DE)

(21) Appl. No.: 16/313,496

(22) PCT Filed: Jun. 8, 2017
(86) PCT No.: PCT/DE2017/000152

§ 371 Date: Jan. 8, 2019

(30) Foreign Application Priority Data
Jun. 28, 2016 (DE) 10 2016 007 795.6
Oct. 27, 2016 (DE) 10 2016 013 071.7

(51) Int. Cl. B01F 7/00; B01F 7/16

(52) U.S. Cl. CPC B01F 7/00275; B01F 7/1675; B01F 7/162; B01F 7/00291

(57) ABSTRACT

A device for treating material in a container which is equipped with a stirrer that can be rotated about a central axis has a first deflecting device which is arranged in the container above the stirrer in order to deflect a material flow transported by the stirrer to the container center. The stirrer has a coaxial axle element, the diameter of which in the region of the stirrer is at least a quarter of the diameter of the stirrer. The container has a base below the stirrer, and the distance between the base and the deflecting device is maximally half the maximum diameter of the container between the base and the deflecting device. The base can also be designed as a perforated sheet.

The invention relates to a device for treating material with a container, in which is arranged a stirrer that can be rotated around a central axis, and with a first deflecting device, which is arranged in the container above the stirrer, so as to deflect a material flow conveyed by the stirrer to the middle of the container.

Different kinds of stirrers are known, which as a rule are open toward the top. Therefore, the material flow is stirred in the stirrer container, and material that is upwardly stirred in the process makes its way toward the top until gravity pulls it back down again.

Publications WO 2011/144196, WO 2012/041269 and WO 2013/135224 show material handling devices with containers, which are shaped in such a way that the material flow conveyed by the stirrer through the inner container wall is deflected toward the center of the container above the stirrer. A central screw guides the material out of an upper area of the container to the stirrer, and from there the material flow wanders radially outward, upward and, guided by the deflecting device, toward the middle of the container.

It was found that, in particular when treating coarse materials, clumps arise that are poorly dissolved in the stirrer, if at all.

Therefore, the object of the invention is to further develop such devices in such a way as to avoid clump formations.

This object is achieved with a generic device, in which the stirrer has a coaxial axle body, the diameter of which in the area of the stirrer measures at least one fourth the diameter of the stirrer.

In order to use the stirrer in the radially outer and also in its radially inner area, it has previously been proposed that that the functional areas of the stirrer be arranged on an axle with a small diameter. The material here gets into the middle of the stirrer, and then from the radially inner areas to the radially outer areas of the stirrer.

The circumferential speed is relatively low in the radially inner areas of the stirrer, so that undesired clumps are most likely to form there. Clump formation can hardly be avoided even by using spiral feeders and specially shaped stirrer arms.

Therefore, the invention is based on the knowledge that the central area of the stirrer in which the axle lies is of secondary importance for stirrer function given the low acceleration present there, and thus should be configured as a coaxial axle body with an enlarged diameter. The coaxial axle body denotes a body formed by the axle itself, a cylinder arranged around the central axle or another body configured so as to keep this middle area free of material. As a result, the material is only treated by the stirrer in an area spaced apart from the middle of the stirrer, and the central area is not accessible for the material, so that no clumps can form there either. However, the circumferential speed is so high in the radially outer area that a good circulation is achieved there, eliminating any concern over clumping.

In order to achieve an especially good circulation at a low energy outlay, it is proposed that the container underneath the stirrer have a base, and that a distance between the base and deflecting device measure at most half the maximum diameter of the container between the base and deflecting device.

It is advantageous that the distance between the central axle and radially outer container inner wall in the area of the stirrer correspond to about the distance between the base and deflecting device. “About” here means a deviation of at most 30%, and preferably of at most 20%, from the larger distance.

The base can here be designed as a continuous floor surface, as in a kneader, or as a perforated sheet, as in a conditioner.

The stirrer or arms of the stirrer should reach as far as possible into the radially outer areas of the container, so that no dead zones come about. Therefore, it is proposed that the diameter of the stirrer measure at least 70%, preferably at least 80%, of the maximum diameter of the container in the area of the stirrer.

An advantageous embodiment provides that the stirrer have one or several arms, which extend radially outward from the central axle body.

An especially simple embodiment provides that the first deflecting device have a circular blank with a central, free passage that is arranged in the container. In a simple embodiment, this is a horizontal sheet with a centrally free passage, which makes it possible to load the container with material.

The container can also be shaped in such a way that the first deflecting device consists of a constriction on the container. As a consequence, the container has a smaller diameter in the area of the deflecting device than below the constriction, and preferably also a smaller diameter than above the constriction. This makes it possible to use the area above the constriction as a feed and buffer area, while the reaction area with the stirrer lies below the constriction.

In order to induce a sufficient inward deflection of the material by means of the first deflecting device on the one hand, and be able to easily supply additional material in a central manner on the other, it is proposed that the first deflecting device have a central, free passage with a diameter of at least 0.8 m. For example, the free passage can have a diameter of less than 80% or even less than 60% of the maximum container diameter.

When using the kneader, the water level should lie in or above the constricted diameter. For example, if the constricted diameter is formed by a plate, the water surface lies in the plane of the plate or somewhat above it. This calms the water surface, and less energy is lost as the result of wave formation.

The free diameter is intended to make it possible to supply the solid to the lower area. This solid should automatically fall into the lower area, thereby eliminating the need for a feed screw.

In a device with two stirrers arranged one over the other, the deflecting device need not be made out of a solid material, since one material flow can serve as a respective deflecting device for the other material flow. For this reason, it is proposed that the first deflecting device be comprised of a material flow conveyed downwardly toward the middle of the container by an additional stirrer arranged above the first stirrer.

It was found that a conveyor arranged above the stirrer that conveys material to the stirrer is not necessary, and can even be harmful. For this reason, it is proposed that the container on the central axle have no conveyor that conveys to the stirrer, at least above the deflecting device.

Suitable as a buffer and for increasing the pressure in the stirrer area is a feed chamber, which is formed above the deflecting device as part of the container. This feed chamber can also be an additional container part, a collar or a cylindrical container part.

In particular when using the device as a kneader, it is advantageous that it have a tangential supply line to the container. As a rule, the feeder already provides the supplied material with a velocity component that can be used for relieving the stirrer given a tangential supply in the container.

Advantageous embodiment variants provide that a second concentric deflecting device be arranged above the stirrer.

This second deflecting device can have a tapered section, which is concentrically arranged above the stirrer. This tapered section is shaped like a cone or truncated cone, and makes it easier to direct the material in the device.

In particular for using the device as a kneader with a tangential inflow, it is proposed that the second deflecting device have a truncated cone that tapers toward the stirrer, so as to divert the material flow deflected radially inwardly to the central axle toward the stirrer. Given two stirrers located one over the other, two truncated cones are used in a corresponding embodiment, whose radially larger circular areas abut against each other.

By contrast, when a central inflow to the device is provided, it is advantageous for the second deflecting device to have a truncated cone that expands toward the stirrer, so as to divert the material flow to the outside.

Especially good mixing results are achieved with devices that have baffle plates on the radially outer container inner wall. For example, this is achieved with a container that has a circumferential wall, whose radially outermost area has at least one continuous kink with an obtuse angle open toward the container inner side. Two kinks are preferably provided, which also make it possible to provide an area of a perpendicular container wall between these kinks.

In a method for operating this device, a fill level above the first deflecting device is preferably set in the container. This provides a material buffer, and the material itself acts to exert pressure on the area in which the stirrer is located. For example, when inserting a plate, it should lie at the liquid level or only slightly thereunder. The liquid above the liquid level technologically only yields an elevated water pressure. The area above the constriction should therefore be only slightly flooded, or not at all.

In an advantageous procedure, the speed of the stirrer is lowered while filling as the load rises.

An average speed should lie at 3 to 10 m/s at the radially outermost stirrer end, with roughly 5 m/s being a good value in practice for combining good mixing with efficient energy input.

The speed of the stirrer can also be set so as to force the material into the radially outer areas of the container in such a way that all material is driven to the outside by the centrifugal force in the middle of the container, preferably in the area of at least 50% of the axis.

Advantageous embodiment variants of devices according to the invention are shown in the drawing, and will be explained in more detail below.

Shown on:

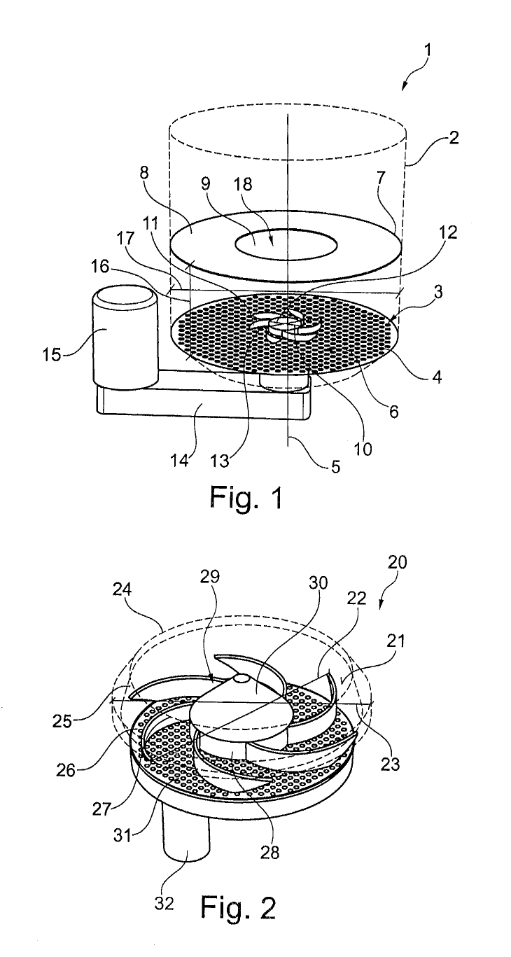

FIG. 1 is a simple embodiment of a device according to the invention with circular blank,

FIG. 2 is an embodiment of the device according to the invention with a truncated cone that expands toward the stirrer,

FIG. 3 is a device with a feed chamber,

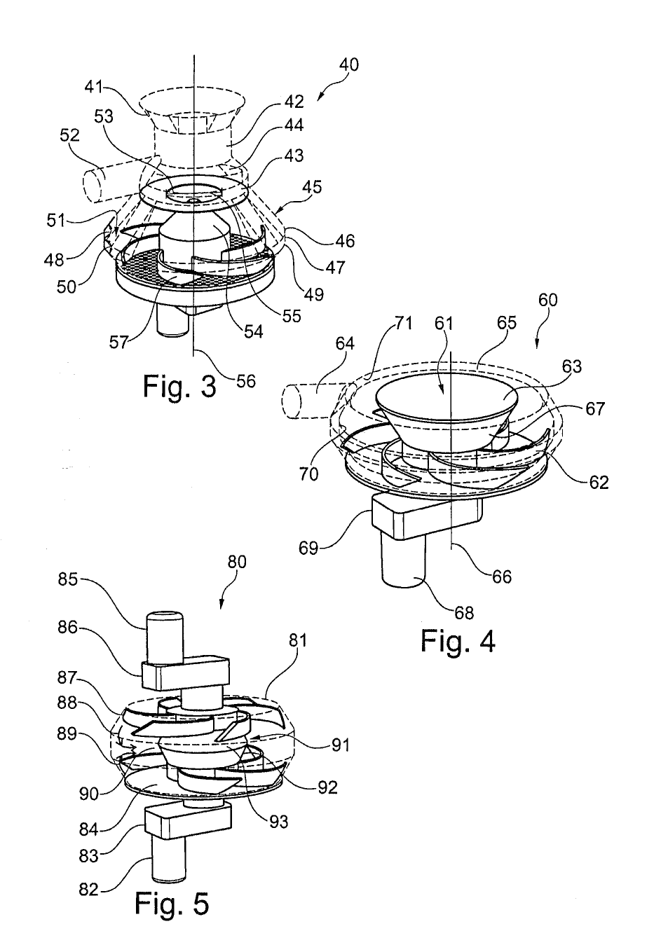

FIG. 4 is a device with a tangential inflow and a truncated cone that tapers toward the stirrer, and

FIG. 5 is a device with two stirrers located one over the other.

The device 1 shown on FIG. 1 has a container 2, in which a screen plate 4 is arranged as the base 3. A stirrer is provided concentrically to the cylindrical container 2 on a central axle 5 directly above the base 3. Provided above the stirrer 6 as a first deflecting device 7 is a horizontally arranged circular blank 8 with a circular, central free passage 9.

The stirrer 6 has a coaxial axle body 10, from which six bent arms 11 radially extend.

The axle body 10 has a diameter 12 in the area of the stirrer 6 whose length measures at least one fourth of the diameter 13 of the stirrer 6.

The stirrer 6 is driven by a gearbox 14 and a motor 5. As a consequence, the arms 11 turn around the central axle 5, so as to circulate material (not shown) between the circular blank 8 and base 3.

To ensure that the material strikes the lower side of the circular blank 8 and is there diverted, the distance 16 between the base 3 and deflecting device 7 measures at most half the diameter 17. The diameter 17 is the maximum diameter of the container 2 between the base 3 and deflecting device 7.

When using the device, material with water above the circular blank 8 is put into container 2. The material falls through the free passage 9 in the area below the circular blank 8 and onto the stirrer 6. This stirrer 6 turns the material in the container 2 between the base 3 and deflecting device 7, wherein the material is upwardly driven by the shape of the container 2 and stirrer 6 in the radially outer area, and flows toward the top until it strikes the lower side of the circular plank 8 and gets to the middle 18 of the container. The material there falls downwardly to the stirrer 6, and is conveyed radially outwardly again by the stirrer 6.

In particular given coarse or pasty material, this gives rise to high shearing forces between the material particles and a thorough mixing of the material.

The material has the lowest circumferential speed in the center of the stirrer 6, which encourages the formation of clumps here. For this reason, the stirrer has the axial axle body 10, which here prevents material from accumulating, and deflects the material radially outward And toward the stirrer arms 11.

FIG. 1 shows an especially small stirrer. A stirrer is advantageously of the kind depicted in device 20. The stirrer 21 here has a diameter 22 almost as large as the maximum diameter 23 of the container 24 between the deflecting device 25 and the base 26 of the container 24.

In this exemplary embodiment, the deflecting device 25 is a container wall that faces radially inward from the maximum container diameter 21, and forms a constriction 27 on the container.

Above the coaxial axle body 28, this container has a tapered section 30 as a second deflecting device 29, which is arranged concentrically above the stirrer 21. This tapered section 30 is shaped like a cone or truncated cone, whose shell surface expands toward the stirrer.

A screen plate 31 is located below the stirrer 21, and under that is the motor 32 as the drive for the stirrer 21.

Material that gets tangentially (not shown) or from above into the container 24 is thus deflected radially outward to the stirrer 21 by the conical jacket surface of the tapered section 30, and wanders upwardly along the inner wall of the container 24 in the radially outward area, so as to be deflected radially inwardly again by the deflecting device 25.

The device 40 shown on FIG. 3 has a funnel 41, which transitions into a cylindrical collar area 42 and then into a feed chamber 44 bordered by a circular blank 43. The container 45 expands below the circular blank 43. The circumferential wall there has a first continuous kink 46 in the radially outermost area of the container 45, which transitions into a short cylindrical jacket area 47, and in so doing forms an obtuse angle 48 open toward the interior side of the container. This is followed toward the bottom by another kink 49, which once again has an obtuse angle 50 open toward the container interior side 51.

As a consequence, the material gets into the feed chamber 44 either via the funnel 41 or via a tangential supply line 52, and from there to the tapered section 54 through the free passage 53. In the exemplary embodiment, the free passage has a diameter 55 of about one meter.

The container 45 has no conveyor that leads to the stirrer 57 both on the central axle 56 and above and below the deflecting device 43.

FIG. 4 also shows a device 60 with a second concentric deflecting device 61 above the stirrer 62. By contrast, this second deflecting device 61 has a truncated cone 63 that tapers toward the stirrer 62. This truncated cone 63 takes the material conveyed through the tangential inflow 64 into the container 65, which is stirred by the stirrer 62 and flows upwardly in radially outer areas of the container 65, and guides it back down to the stirrer 62. This is accomplished by means of a conical circumferential surface 67 that is concentric to the central axle of the container 65.

The gearbox 69 of the motor 68 drives the stirrer 62, which stirs the material in the container 65, during which the material is first made to flow upwardly by the stirrer shape, centrifugal forces and shape of the inner wall 70 of the container 65. The material then gets to an inner container wall 71 above the stirrer 62, which as the first deflecting device deflects the material toward the central axle 66. The material is then deflected back down to the stirrer 62 via the conical jacket surface 67 of the truncated cone 63. The material thus circles around a central annular axis of a torus and stirrer and container shape, and the deflecting devices are designed so as to, if at all possible, produce no areas with an especially low speed. This leads to an intensive mixing, and prevents clump formation.

In the device 80 shown on FIG. 5, the first deflecting device need not necessarily be a container wall or container insert, but rather can also be provided by a second material flow. This device 80 has a container 81, in which a first motor 82 and a first gearbox 83 drive a first stirrer 84 in the container 81. Located above that is the second motor 85, which drives a stirrer 87 in the container 81 via a second gearbox 86. The stirrer 87 thus produces a downward material flow, while the stirrer 84 produces an upward material flow. At the location where these material flows meet, the lower material flow forms a deflecting device for the upper material flow, and the upper material flow forms a deflecting device for the lower material flow. The material flow 88 generated by the second stirrer 87 thus forms the first deflecting device for the material flow 89 produced by the stirrer 84 toward the container middle 90.

Arranged in the middle of the container as a coaxial axle body is a double tapered section 91, which has a lower conical jacket surface 92 that tapers toward the stirrer, so as to deflect the material flow 89 toward the stirrer 84.

The upper side of the double tapered section 91 has a conical jacket surface 93 that tapers toward the stirrer 87, which deflects the material flow 88 toward the stirrer 87.

As evident from the device shown on FIG. 3, it is advantageous that the fill level (not depicted) in the container be set above the first deflecting device 43. As a result, the feed chamber 44 along with the chamber above that up to the funnel 41 can be used as a storage space for material, and a liquid material or a filling with liquid or water produces a hydrostatic pressure that acts on the material in the area of the stirrer 57.

In order to achieve the desired material flow in the container 45, it is proposed that the speed of the stirrer be lowered while filling the container 45 with material as the load increases. This makes it possible to achieve an especially intensive circulation of the material at a low power consumption.

1: A device for treating material with a container (2), in which is arranged a stirrer (6) that can be rotated around a central axis (5), and with a first deflecting device (7), which is arranged in the container (2) above the stirrer (6), so as to deflect a material flow conveyed by the stirrer (6) to the middle of the container, wherein the stirrer (6) has a coaxial axle body (10), the diameter (12) of which in the area of the stirrer (6) measures at least one fourth the diameter (13) of the stirrer (6).

2: The device according to claim 1, wherein the container (2) underneath the stirrer (6) has a base (3), and wherein a distance (16) between the base (3) and deflecting device (7) measures at most half the maximum diameter (17) of the container (2) between the base (3) and deflecting device (7).

3: The device according to claim 1, wherein the diameter (22) of the stirrer (21) measures at least 70%, preferably at least 80%, of the maximum diameter (23) of the container (24) between the base (26) and deflecting device (25).

4: The device according to claim 1, wherein the stirrer (6) has one or several arms (11), which extend radially outward from the central axle body (10).

5: The device according to claim 1, wherein the first deflecting device (7) has a circular blank (8) with a central, free passage (9) that is arranged in the container (2).

6: The device according to claim 1, wherein the first deflecting device (25) comprises a constriction (27) on the container (24).

7: The device according to claim 1, wherein the first deflecting device (7, 43) has a central, free passage (9, 53) with a diameter (55) of at least 0.8 m.

8: The device according to claim 1, wherein the first deflecting device is comprised of a material flow (88) conveyed downwardly toward the middle of the container by an additional stirrer (87) arranged above the first stirrer (84).

9: The device according to claim 1, wherein the container (45) on the central axle (56) has no conveyor that conveys to the stirrer (57), at least above the deflecting device (43).

10: The device according to claim 1, wherein the container (45) has a feed chamber (44) above the deflecting device (43).

11: The device according to claim 1, wherein it has a tangential supply line (52) to the container (45).

12: The device according to claim 1, wherein it has a second concentric deflecting device (29, 61) above the stirrer (21, 62).

13: The device according to claim 12, wherein the second deflecting device (29) has a tapered section (30), which is concentrically arranged above the stirrer (21).

14: The device according to claim 12, wherein the second deflecting device (61) has a truncated cone (63) that tapers toward the stirrer (62), so as to divert the material flow deflected radially inwardly to the central axle (66) toward the stirrer (62).

15: The device according to claim 12, wherein the second deflecting device (29) has a cone (30) or truncated cone that expands toward the stirrer (21), so as to divert the material flow radially outward.

16: The device according to claim 1, wherein the container (45) has a circumferential wall (46), whose radially outermost area has at least one continuous kink (46, 49) with an obtuse angle (48, 50) open toward the container inner side.

17: A method for operating a device according to claim 1, wherein a fill level above the first deflecting device (43) is set in the container (45).

18: The method according to claim 17, wherein the speed of the stirrer (57) is lowered while filling as the load rises.
